(19) United States
(12) Patent Application Publication
(10) Pub. No.: US 2004/0259015 A1
(43) Pub. Date: Dec. 23, 2004

(54) Recording liquid and image forming method using the recording liquid

(76) Inventors: Kazuo Tsubuko, Numazu-shi (JP); Tsuyoshi Asami, Yokohama-shi (JP); Aiko Ishikawa, Numazu-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/867,796

(22) Filed: Jun. 16, 2004

(30) Foreign Application Priority Data
Jun. 19, 2003 (JP) 2003-175333

(51) Int. Cl. G03G 9/125

(52) U.S. Cl. 430/116; 430/117

(57) ABSTRACT

A recording liquid including a colorant and a carrier liquid including at least a poly-α-olefin. The recording liquid can be used as a liquid developer, an inkjet ink, a printing ink, a marker ink, an electronic recording ink, or the like. An image forming method including the steps of applying a recording liquid on a liquid bearing member to form a layer of the recording liquid; and developing an electrostatic latent image born on an image bearing member by bringing the layer of the recording liquid into contact with the image bearing member to form a visual image on the image bearing member.

### BACKGROUND OF THE INVENTION

1. Field of the Invention

The present invention relates to a recording liquid such as liquid developers for use in electrophotography, electrostatic recording and electrostatic printing; print inks; inkjet inks; marker inks; and electronic recording inks. In addition, the present invention also relates to an image forming method using the recording liquid. The recording liquid can also be used as a non-aqueous paint.

2. Discussion of the Background

Electrophotographic developers are classified into dry developers and liquid developers. Liquid developers have an advantage over dry developers such that clear images can be produced because of including a toner having a smaller particle diameter than that of the toner included in the dry developers.

Liquid developers are typically prepared by dispersing a resin, a colorant and a charge controlling agent in a non-aqueous solvent having a high electric resistance. The particle diameter of the toner dispersed in such liquid developers is typically from about 0.1 to about 2.0 μm. In addition, liquid developers do not use an iron power carrier, which is typically used for dry developers and has a heavy weight, when images are formed. Therefore the liquid developers have the following advantages over dry developers:

(1) the stress applied to image forming apparatus is much less than that applied to image forming apparatus by dry developers; and

(2) high speed image recording can be performed.

As to the image fixing method for fixing an image formed by a liquid developer on a receiving material, the following fixing methods are well known:

(1) a fixing method in which an image is fixed by bringing the image into contact with a heat roller;

(2) a fixing method in which an image is fixed by being heated with hot air;

(3) a fixing method in which an image on a receiving material is fixed by bringing the backside of the receiving material into contact with a hot plate; etc.

In any one of the fixing methods mentioned above, the solvent in the liquid developer used is released into atmosphere. This is not preferable in view of environmental protection.

In attempting to prevent releasing of solvent vapors, published unexamined Japanese Patent Application No. (hereinafter referred to as JP-A) 09-208873 discloses a fixing method in which an image formed by a liquid developer is fixed by being exposed to ultraviolet rays. However, the method has a disadvantage such that the image forming apparatus using the method becomes large in size.

JP-As 63-301966 to 301969, 64-50062 to 50067, 64-52167 and 64-142560 to 142561 have disclosed liquid developers for use in the image forming method using a heat fixing roller mentioned above. These liquid developers include an aliphatic hydrocarbon having a low boiling point as a main component of the carrier liquid. Therefore, the aliphatic hydrocarbon is released from the image forming apparatus into atmosphere. In addition, a silicone oil has to be applied to the heat fixing roller to prevent an offset problem in that a toner image adheres to the fixing roller. Therefore the image forming apparatus has problems in that the constitution of the image forming apparatus becomes complex and the number of consumable supplies (parts) increases. In addition, silicone oils have excellent releasability. When a print image is adhered to a good with a tape, a problem in that the tape is easily released from the image occurs. Further, there is no liquid developer which has a property such that when an image which is formed by the liquid developer on an image bearing member, such as photoreceptors and intermediate transfer media, is transferred to a receiving material, the toner image is fixed on the receiving material at the same time.

In inkjet recording methods, an ink drop is discharged from a recording head toward a receiving material to record an image on the receiving material, wherein the ink typically penetrates into the receiving material (i.e., the receiving material absorbs the ink). Such inkjet recording methods have the following advantages:

(1) images can be recorded quietly (with low noise);

(2) color images can be recorded at a relatively high speed; and

(3) plain papers can be used as the receiving material.

Therefore, recently the inkjet recording methods have been popularly used for image forming apparatus such as printers and facsimile machines.

As the ink for use in such inkjet recording methods, oil-based inks in which an oil-soluble dye is dissolved in an oil solvent, and aqueous inks in which a water-soluble dye is dissolved in an aqueous solvent are well known.

The oil-based inks typically have the following advantages:

(1) images can be recorded on various receiving materials;

(2) recorded images are quickly dried (images quickly penetrate into receiving materials and can be absorbed by the receiving materials);

(3) recorded images have good water resistance; and

(4) the chance of occurrence of a clogging problem in that a nozzle is clogged with particles of the dye included in the inkjet ink used, resulting in occurrence of image omissions, is less than in the case of using an aqueous ink.

However, even such oil-based inks are used, occurrence of the clogging problem cannot be prevented because the organic solvents included in the inks evaporate in nozzles, resulting in solidification or aggregation of the oil-soluble dye in nozzles. In addition, such oil-based inks typically include a solvent having a high boiling point. When such a solvent having a high boiling point is used, images having a high image density cannot be obtained (i.e., high quality images cannot be obtained).

As for the marker ink, inks in which an oil soluble dye or pigment is dissolved or dispersed in an organic solvent having a relatively low boiling point are popularly used. As the organic solvent, aromatic solvents such as toluene and xylene are typically used. However, odor and toxicity of such aromatic solvents present a problem. Therefore, recently solvents having relatively low toxicity, such as alcohols, etyleneglycol monoalkyl ethers (i.e., cellosolves), and propyleneglycol monoalkyl ethers are typically used as the main solvent of quick-drying marker inks.

Such marker inks typically include an oil-soluble dye selected from the dyes listed in Color Index. For example, dyes prepared by mixing a leuco dye of a basic dye with an organic acid; dyes including a salt prepared by reacting a basic dye with an acidic dye or a fatty acid; or dyes prepared by changing an acidic dye into an amine salt thereof, are typically used. These techniques have been disclosed in published examined Japanese Patent Application No. 49-19175 (method for manufacturing dye ink for felt pen); JP-A 62-174282 (oil-based ink); JP-A 62-207377 (oil-based marking ink composition); JP-A 63-75068 (alcohol-soluble dye composition); and JP-A 64-87677 (marking ink composition). However, these inks are not satisfactory in view of odor, writing property, preservability, and safety of life.

Electronic recording inks are used for forming character and photographic images by moving particles of an ink upon application of an electric field thereto, wherein the ink includes ink particles dispersed in an insulating liquid and is contained in a container prepared by a transparent paper such as cellophane. The ink particles are small in size and charged, and therefore they can be moved upon application of a certain voltage thereto. However, the images exhibited by conventional electronic recording inks have poor contrast, and in addition the response of the electronic recording inks to application of voltage is unsatisfactory. Further, the inks are unsatisfactory in view of odor.

Because of these reasons, a need exists for a liquid developer which can be used for electrophotographic image forming methods and which can produce (color) images with high image density, high resolution, good color reproducibility and less blurring while the amount of evaporation of the solvent used is decreased. In addition, a need exists for an oil-based inkjet ink which can produce images having good image density and good color reproducibility without causing a clogging problem. Further, a need exists for a maker ink, and the like inks, which can produce images having good fixability on various materials and which have good odor and toxicity properties while the amount of evaporation of the solvent used is decreased. Furthermore a need exists for an electronic recording ink which can repeatedly exhibit images having good contrast for a long period of time.

### SUMMARY OF THE INVENTION

Accordingly, an object of the present invention is to provide a liquid developer for electrophotography which can produce images with high image density, high resolution, good color reproducibility and less blurring while the amount of evaporation of the solvent used therein is decreased. Specifically, an object of the present invention is to provide a liquid developer for electrophotographic image forming method in which when an image is transferred on a receiving material, the image is fixed at the same time, wherein the toner image has high image density, high resolution and good color reproducibility and the amount of evaporation of the solvent used therein is decreased.

Another object of the present invention is to provide an inkjet ink which has good preservability without causing a clogging problem caused by evaporation of the solvent used and which can produce images having high image density and good color reproducibility.

Yet another object of the present invention is to provide a marker ink which can produce having good fixability and which has good odor and toxicity properties.

A further object of the present invention is to provide an electronic recording ink which can repeatedly exhibit high contrast images and which has good odor properties.

A still further object of the present invention is to provide an image forming method which uses a liquid developer and by which color images with high image density, high resolution and good color reproducibility can be produced while the evaporation amount of the solvent included therein is decreased.

To attain such objects, the present invention contemplates the provision of a recording liquid (e.g., a liquid developer, a printing ink (e.g., a stencil ink), an inkjet ink, a marker ink, an electronic recording ink, etc.) including a carrier liquid and a colorant dispersed in the carrier liquid, wherein the carrier liquid includes a poly-α-olefin. It is preferable that the carrier liquid further includes a resin and/or a charge controlling agent.

The colorant is preferably subjected to a flushing treatment using a resin which is preferably selected from the group consisting of ethylene/vinyl acetate copolymers, polyester resins, crystalline polyester resins, styrene-acrylic copolymers, rosin-modified resins (such as rosin-modified phenolic resins and rosin-modified maleic resins), polyethylenes, ethylene/(meth)acrylic acid copolymers, ethylene/acrylate copolymers, ethylene/maleic anhydride copolymers, polyvinyl pyridine and polyvinyl pyrrolidone. Alternatively, the colorant may be kneaded together with the resin using a heat roller or the like. The resin preferably has a softening point of from 30 to 120° C.

The content of each of the resin and colorant to the total weight of the recording liquid is preferably not less than 5% based on the total weight of the recording liquid.

The particles dispersed in the recording liquid preferably have an average particle diameter of from 0.01 to 15 μm, when the recording liquid is used for a liquid developer for electrophotography.

The recording liquid preferably has a viscosity not less than 10 mPa.s at 25° C.

The poly-α-olefin preferably has a flash point not lower than 130° C. and a viscosity not less than 3 mPa.s at 40° C.

It is preferable that the recording liquid further includes a silicone oil having a flash point not lower than 210° C., a liquid paraffin, and/or an aliphatic hydrocarbon as a carrier liquid. In addition, vegetable oils, soybean oils, corn oils, caprylic/capric triglyceride), neopentyl glycol dicaprate, isooctyl ester of iso-octyl acid, and isonoyl ester of iso-nonanoic acid.

In another aspect of the present invention, an image forming method is provided which includes the steps of:

applying the above-mentioned recording liquid (i.e., the liquid developer) on a liquid bearing member such as rollers and belts to form a thin layer of the recording liquid on the liquid bearing member; and

developing an electrostatic latent image born on an image bearing member (e.g., photoreceptors) with the thin layer of the liquid developer to form a visual image (e.g., toner image) on the image bearing member.

It is preferable that the image forming method further includes the step of subjecting the thin layer to corona-discharging before the developing step; and/or the step of applying a pre-wet liquid to at least the electrostatic latent image before the developing step.

The toner image can be transferred to a receiving material optionally via an intermediate transfer medium. The contact angle formed by the liquid developer and the image bearing member is preferably not less than 30°. The toner image is preferably fixed at the same time when the toner image is transferred. In addition, the image bearing member is preferably a photoreceptor including amorphous silicon as the photosensitive material.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

FIG. 1 is a schematic view illustrating an image forming apparatus for use in the image forming method of the present invention;

FIG. 2 is a schematic view illustrating another image forming apparatus for use in the image forming method of the present invention;

FIG. 3 is a schematic view illustrating yet another image forming apparatus for use in the image forming method of the present invention;

FIG. 4 is a schematic view illustrating yet another image forming apparatus for use in the image forming method of the present invention;

FIG. 5 is a schematic view illustrating yet another image forming apparatus for use in the image forming method of the present invention;

FIG. 6 is a schematic view illustrating yet another image forming apparatus for use in the image forming method of the present invention;

FIG. 7 is a schematic view illustrating yet another image forming apparatus for use in the image forming method of the present invention; and

FIG. 8 is a schematic view illustrating yet another image forming apparatus for use in the image forming method of the present invention.

### DETAILED DESCRIPTION OF THE INVENTION

The recording liquid of the present invention will be explained in detail while mainly referring to a liquid developer for use in electrophotography, but the present invention also relates to a printing ink (e.g., a stencil ink), an inkjet ink, a marker ink, a paint, and an electronic recording ink as well as the liquid developer (hereinafter these liquid developer, and inks are sometimes referred to as a recording liquid). The recording liquid of the present invention is characterized by including at least a colorant and a poly-α-olefin. Namely, the recording liquid of the present invention includes a non-aqueous dispersion medium including at least a poly-α-olefin. Therefore, the recording liquid has good odor and toxicity properties, and high safety. In addition, the recording liquid is environmentally friendly. Further, the recording liquid has good preservability, and can produce images having high gloss, good water resistance and good color reproducibility. Furthermore, the images recorded by the recording liquid of the present invention hardly causes the tape releasing problem in that a tape adhered to a sheet having a recorded image thereon is released therefrom.

The recording liquid of the present invention preferably includes a resin, and a dispersant (i.e., a charge controlling agent). When the recording liquid includes a resin, and a dispersant, images with less blurring, high image density, high resolution, good color reproducibility and good preservability can be produced.

Specific examples of the dispersant (i.e., charge controlling agent) include metal soaps such as zirconium naphthenate, ferric naphthenate, ferrous naphthenate, manganese naphthenate, cobalt naphthenate, nickel naphthenate, copper naphthenate, aluminum naphthenate, tin naphthenate, zirconium octylate, ferric octylate, ferrous octylate, manganese octylate, cobalt octylate, nickel octylate, copper octylate, aluminum octylate, and tin octylate; resin dispersions such as dispersions of acrylic polymers, acrylic copolymers, and rosin-modified maleic acid copolymers; other known charge controlling agents such as metal complexes of azo dyes, metal complexes of salicylic acid derivatives, quaternary ammonium salts, and nigrosine dyes; etc.

Recently, an image fixing method in which an image formed by a recording liquid is fixed using a heat roller is proposed. The recording liquid includes a hydrocarbon solvent as a carrier liquid. When this fixing method is used, the amount of the solvent vapor is slightly low compared to that in the cases using conventional fixing methods in which the image on the receiving material is heated with hot air instead of a heat roller. However, when a number of images are continuously produced at a high speed, a large amount of solvent vapor is produced.

The recording liquid of the present invention includes a poly-α-olefin as a carrier liquid. Among poly-α-olefins, poly-α-olefins having a flash point not lower than 130° C., and a viscosity not lower than 3 mPa.s at 40° C. are preferably used. It is preferable that the recording liquid further includes a silicone oil having a flash point not lower than 210° C., a liquid paraffin, an aliphatic hydrocarbon, and/or a vegetable oil, to reduce the amount of the carrier liquid vapor and to produce high quality images with high image density, good sharpness, and good solid image uniformity. By using such a recording liquid, an image recorded on an image bearing member is fixed on a receiving material concurrently with transferring of the images on the receiving material.

Poly-α-olefins can well disperse colorants (such as pigment) therein. Since a colorant can be efficiently dispersed in a poly-α-olefin, the colorant is finely dispersed in the poly-α-olefin in the resultant recording liquid. Such a recording liquid can produce images having good resolution.

When a colorant is dispersed in a carrier liquid including a poly-α-olefin, it is preferable that at first the colorant is previously dispersed in the poly-α-olefin using a dispersing machine, and then the mixture is mixed with one or more carrier liquids such as silicone oils, liquid paraffins, aliphatic hydrocarbons and vegetable oils. In this regard, the amount of the other carrier liquids is from 0 to 50% by weight, and preferably from 5 to 30% by weight, based on the total weight of the recording liquid. It is preferable that the mixture is further subjected to a dispersing treatment. By using this method, colorants can be finely dispersed efficiently in carrier liquids.

When only a silicone oil is used as the carrier liquid, the produced image causes the tape peeling problem in that a tape adhered to the sheet having the image is easily released therefrom. However, when a poly-α-olefin is used, such a problem is hardly caused.

Poly-α-olefins for use in the recording liquid of the present invention are typically synthesized as follows while ethylene is used as a source material.

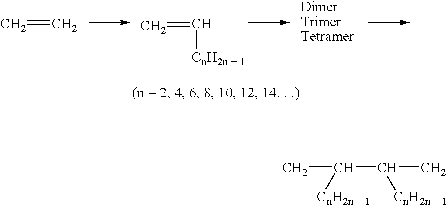

Specific examples of the marketed poly-α-olefins include SHF-20, SHF-21, SHF-23, SHF-41, SHF-61, SHF-63, SHF-82, SHF-83, SHF-101, SHF-403, SHF-1003, SUPERSYN® 2150, SUPERSYN® 2300, SUPERSYN® 21000, and SUPERSYN® 23000, which are manufactured by Exxon Mobil. The physical properties of the poly-α-olefins are shown in Table 1 below.

TABLE 1

| | Viscosity | Molecular | | |
|---|---|---|---|---|
| | at 20° C. | weight | Flash point | Specific |
| Name | (mPa · s) | (Mn) | (° C.) | gravity |
| SHF-20 | 8.5 | 282 | 157 | 0.798 |
| SHF-41 | 36.3 | 431 | 220 | 0.820 |
| SHF-61 | 58.1 | 527 | 246 | 0.827 |
| SHF-82 | 118 | 611 | 260 | 0.833 |
| SHF-101 | 164 | 687 | 266 | 0.835 |
| SHF-403 | 1221 | 1758 | 281 | 0.850 |
| SHF-1003 | 4953 | 2939 | 283 | 0.853 |
| SUPERSYN ® | 4300 | 3500 | Not lower | 0.850 |
| 2150 | | | than 265 | |
| SUPERSYN ® | 9376 | 5100 | Not lower | 0.852 |
| 2300 | | | than 265 | |
| SUPERSYN ® | 41069 | 11500 | Not lower | 0.855 |
| 21000 | | | than 265 | |
| SUPERSYN ® | 107890 | 20900 | Not lower | 0.855 |
| 23000 | | | than 265 | |

liquid paraffins and aliphatic hydrocarbons, other than poly-α-olefins.

Specific examples of the silicone oils include KF-995 and KF-994 (manufactured by Shin-Etsu Chemical Co., Ltd.). Specific examples of the silicone oils having a flash point not lower than 210° C. include KF-96 (having a viscosity of from 20 to 10000 cst, from Shin-Etsu Chemical Co., Ltd.); SH344 (from Toray Silicone Industries, Inc.); and TSF451 Series, TSF404 (cyclic dimethylpolysiloxane), and TSF4704 (amino-modified silicone oil), which are manufactured by Toshiba Silicone Co., Ltd.

Specific examples of the liquid paraffins include CRYSTOL® J-52, J-72 and J-352 manufactured by Esso Sekiyu K K.

Specific examples of the aliphatic hydrocarbons include ISOPAR® M and ISOPAR® K, which have a relatively high boiling point and which are manufactured by Exxon Mobil.

When a silicone oil is used in combination with a poly-α-olefin, the weight ratio (SO/PO) of the silicone oil (SO) tothepoly-α-olefin (PO) is from 0/100to 90/10, and preferably from 5/95 to 50/50. When the content of poly-α-olefin is too low, the pigment is not well dispersed in the carrier liquid, resulting in deterioration of the dispersing efficiency. In addition, the resulting images have poor resolution and color reproducibility. Further, the rapid fixability tends to deteriorate. When the content of poly-α-olefin is too high, there is a case in which an offset problem in that an image is adhered to a heat roller and the image is re-transferred onto an undesired portion of a receiving material occurs. The same is true for the ratio of a liquid paraffin to a poly-α-olefin, and the ratio of an aliphatic hydrocarbon to a poly-α-olefin.

Specific examples of the colorant include known inorganic pigments such as PRINTEX V, U and G, and SPECIAL BLACK 4, and 4-B which are manufactured by Degussa; #44, #30, MR-11 and MA-100 which are manufactured by Mitsubishi Kasei Corporation; RAVEN 1035 and 1252, and NEWSPECT 11 which are manufactured Columbian Carbon Co.; and REGAL 400 and 660, and BLACK PEARL 900, 1100 and 1300, and MOGUL L which are manufactured by Cabot Corp.; and know organic pigments such as Phthalocyanine Blue, Phthalocyanine Green, Sky Blue, Rhodamine Lake, Malachite Green Lake, Methyl Violet Lake, Peacock Blue Lake, Naphthol Green B, Naphthol Green Y, Naphthol Yellow S, Naphthol Red, Lithol Fast Yellow 2G, Parmanent Red 4R, Brilliant Fast Scarlet, HANSA® Yellow, Benzidine Yellow, Lithol Red, Lake Red C, Lake Red D, Brilliant Carmine 6B, Permanent Red F5R, Pigment Scarlet 3B, indigo, Thioindigo Oil Pink, and Bordeaux 10B.

In particular, when these pigments are used for a liquid developer after subjected to a flushing treatment, the liquid developer can produce images having good image qualities. The flushing treatment is typically performed as follows:

(1) a dye is dissolved or dispersed in water to prepare a solution or dispersion;

(2) a resin solution or dispersion is added to the dye solution and they are mixed in a kneader (i.e., a flusher) to replace water surrounding the dye with the resin solution;

(3) the water is discharged to prepare a dispersion in which the dye is dispersed in the resin solution;

(4) the solvent is removed from the dispersion to prepare a mixture bulk of the dye and resin; and

(5) the mixture bulk is pulverized to prepare a colorant powder.

Colorants in which a colorant is mixed with a resin by other methods such as masterbatch methods and kneading methods using a heat roller can also be used for the recording liquid of the present invention.

The resin for use in the flushing treatment is preferably a resin having a softening point of from 30 to 120° C. in view of the fixability of the resultant toner and the preservability of the resultant recording liquid. Specific examples of such resins include SANWAX® E200 (having a softening point of 95° C.) and 131-P (having a softening point of 108° C.) which are manufactured by Sanyo Chemical Industries Ltd.; AC POLYETHYLENE 1702 (having a softening point of 85° C.) and 430 (having a softening point of 60° C.) which are manufactured by Allied Chemical Corp.; BR-95 (having a softening point of 80° C.) and 101 (having a softening point of 50° C.) which are manufactured by Mitsubishi Rayon Co., Ltd.; polyester resins, styrene/acrylic copolymers, polyvinyl pyridine, polyvinyl pyrrolidone, rosin-modified resins, ethylene/acrylic copolymers, ethylene/maleic anhydride copolymers, etc.

In particular, ethylene-vinyl acetate copolymers (which are manufactured by Mitsui-Du Pont Polychemical Co., Ltd.) are preferably used as the flushing resin.

The liquid developer of the present invention preferably includes a resin configured to disperse the colorant included therein. Specific examples of such a resin include synthetic polymers. In particular, polymers (such as homopolymers, copolymers and graft copolymers) including units obtained from one or more monomers selected from monomers having the below-mentioned formula (A); one or more monomers selected from monomers having the below-mentioned formula (B); and one or more monomers selected from the group consisting of vinyl pyridine, vinyl pyrrolidone, ethylene glycol dimethacrylate, styrene, divinyl benzene, and vinyl toluene, are preferably used.

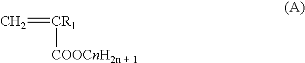

wherein R₁ represents a hydrogen atom or a methyl group; and n is an integer of from 6 to 20.

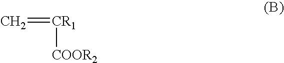

wherein R₁ represents a hydrogen atom or a methyl group; and R₂ represents —H, —CₙH₂ₙ₊₁ (n is an integer of from 1 to 5), —C₂H₄OH, or —C₂H₄N (CₘH₂ₘ₊₁)₂ (m is an integer of from 1 to 4).

In addition, ethylene/vinyl acetate copolymers, polyester resins, crystalline polyester resins, rosin resins, modified rosin resins, polyethylene resins, ethylene/acrylic copolymers, ethylene/maleic anhydride copolymers, or the like resins can also be used for dispersing the colorant.

In order to improve dispersibility of these resins in silicone oils, a silicon compound having an acryloyl group, such as LS4080 manufactured by Shin-Etsu Silicone Co., Ltd., may be copolymerized when the resins are prepared. In addition, AK-5 manufactured by Toagosei Co., Ltd., and TM0701, FM0711, FM0721 and FM0725 can also be used as the silicone compound.

The liquid developer of the present invention is typically prepared, for example, by the following method:

(1) mixing (and kneading) a colorant and a resin using a dispersing machine such as ball mills, KEDDY MILLs, disc mills and pin mills to prepare a dispersion (i.e., a concentrated toner); and

(2) dispersing the dispersion in a carrier liquid.

The liquid developer of the present invention preferably has a viscosity not lower than 10 mPa.s at 25° C. The viscosity is measured by a B type viscometer while the rotor is rotated at a revolution of 60 rpm. When the viscosity is too low, a thin liquid layer cannot be formed on a liquid bearing member such as rollers or belts.

The content of each of the colorant and resin in the liquid developer is preferably not less than 5% by weight, and preferably not less than 10% by weight, based on total weight of the liquid developer. When the content is too low, there is a case where the resultant images have low image density.

The toner particles dispersed in the liquid developer of the present invention preferably have an average particle diameter of from 0.01 to 15 μm. When the average particle diameter is too small, the resultant images have low image density. In contrast, when the average particle diameter is too large, the resultant images have low resolution.

The liquid developer of the present invention is preferably used for an image forming method in which an electrostatic latent image formed on an image bearing member such as photoreceptors is developed with the recording liquid of the present invention to form a visual image (i.e., a toner image) on the image bearing member, and the toner image is transferred onto a receiving material such as papers and plastic sheets and then fixed thereon.

In this image forming method, an electrostatic latent image is preferably developed with a thin layer of the liquid developer of the present invention formed on a roller or a belt. The thickness of the thin layer is preferably from 1 to 15 μm, and more preferably from 3 to 10 μm. When the liquid developer layer is too thin, the resultant images have low image density. In contrast, when the liquid developer layer is too thick, the resolution of the resultant images deteriorates.

When an electrostatic latent image is developed with a thin liquid layer of the recording liquid, it is preferable that the layer is preliminarily subjected to a corona discharge treatment to improve cohesion of the toner therein, i.e., to improve the resolution of the resultant images. In this case, the polarity of the voltage applied for corona discharging is preferably the same as that of the charged toner, and the voltage is preferably from 500 to 8,000 V. Even when the polarity of the voltage applied for corona discharging is opposite to that of the charged toner, the above-mentioned effect can be often produced depending on the charge properties of the toner.

In addition, it is preferable that an electrostatic latent image is developed with a thin layer of the liquid developer after the electrostatic latent image area of the image bearing member is pre-wet with a pre-wet liquid, to improve the transfer efficiency of the toner particles, resulting in production of high quality images. The application of the pre-wet liquid is preferably performed by a roller or a method in which the pre-wet liquid is sprayed. The thickness of the pre-wet liquid formed on the image bearing member is generally from 0.1 to 5 μm, and preferably from 0.3 to 1 μm. When the pre-wet liquid layer is too thin, the above-mentioned effect can be hardly produced. In contrast, when the pre-wet liquid layer is too thick, the resolution of the resultant images tends to deteriorate.

In the image forming method of the present invention, it is preferable that the toner images formed on the image bearing member are transferred onto an intermediate transfer medium, and the toner image is then transferred onto a receiving material such as papers to produce high quality images even on a plain paper. By using such an intermediate transfer medium, the toner images on the intermediate transfer medium can be transferred onto a receiving material while a pressure is applied to the intermediate transfer medium, resulting in formation of high quality images even on plain papers.

Suitable materials for use as the intermediate transfer medium include materials having good solvent resistance and good elasticity, such as urethane rubbers, nitrile rubbers, and hydrin rubbers. It is more preferable to coat the surface of the intermediate transfer medium with a fluorine-containing resin or the like material.

In addition, when the intermediate transfer medium includes a heater therein, toner images can be fixed on receiving materials concurrently with transferring of the toner images on the receiving materials.

In addition, when amorphous silicon is used as the photoreceptor serving as an image bearing member, the image qualities can be enhanced while the photoreceptor has good durability. In particular, the effects are prominent when the photoreceptor is used for the image forming process in which toner images are fixed on receiving materials at the same time when the toner images are transferred on the receiving materials.

The surface of the image bearing member (e.g., a photoreceptor) is preferably water-repellant and oil-repellant such that the contact angle formed by the liquid developer and the surface of the image bearing member is not less than 30° to improve the transfer efficiency of toner images and cleaning property of the image bearing member, resulting in improvement of the image qualities of the resultant images. It is preferable to improve the water-repellant and oil-repellant property of the image bearing member by coating a fluorine-containing block polymer (e.g., MODIPER® F200 and 210 manufactured by NOF Corporation) on the surface of the image bearing member.

Then the image forming method of the present invention will be explained in detail referring to figures.

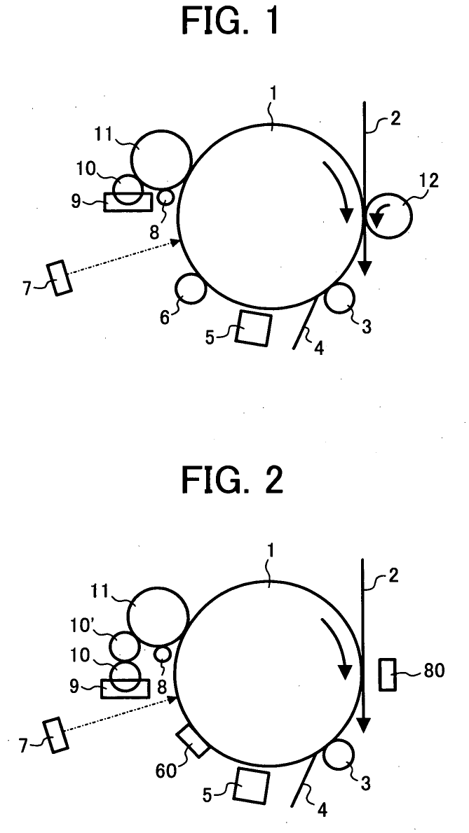

FIG. 1 is a schematic view illustrating an image forming apparatus for use in the image forming method of the present invention.

In FIG. 1, numeral 1 denotes a photoreceptor which includes a photosensitive material such as organic photoconductors, selenium or amorphous silicon and which rotates in a direction as indicated by an arrow. A corona charger 5 charges the photoreceptor 1 while the photoreceptor 1 is rotated. Then imagewise light 7 irradiates the charged photoreceptor 1 to form an electrostatic latent image on the photoreceptor 1. A pre-wet roller 6 applies a pre-wet liquid (i.e., a carrier liquid) to the surface of the photoreceptor 1 when it is desired to preliminarily wet the photoreceptor 1. A transfer roller 10 applies a recording liquid (i.e., a liquid developer), which is contained in a developer container 9, on the surface of a developing roller 11. Thus a uniform liquid developer layer is formed on the developing roller 11. If desired, a corona charger 8 applies a voltage to the developer layer on the developing roller 11. The electrostatic latent image formed on the photoreceptor 1 is developed with the toner in the developer layer formed on the developing roller 11, resulting in formation of a visual image (i.e., a toner image) on the photoreceptor 1.

As the rollers mentioned above, any known rollers such as metal rollers, rubber rollers, plastic rollers and sponge rollers can be used. In addition, wire bars and gravure rollers which have grooves or cups on the surface thereof can also be used as the rollers.

The toner image formed on the photoreceptor 1 is transferred on a receiving material 2 by a transfer roller 12. The toner image transferring operation is performed upon application of pressure, corona charging, heat, a combination of heat with pressure, a combination of corona charging with pressure, a combination of corona charging with heat or the like.

Around the surface of the photoreceptor 1, a cleaning roller 3 and a cleaning blade 4 are arranged to remove toner remaining on the surface of the photoreceptor 1 after the toner image is transferred.

FIG. 2 is a schematic view illustrating another image forming apparatus for use in the image forming method of the present invention. The differences between the image forming apparatus as shown in FIG. 2 and the image forming apparatus as shown in FIG. 1 are as follows.

The pre-wet liquid is coated on the surface of the photoreceptor 1 by a felt 60 instead of the pre-wet roller 6. The liquid developer is transferred from the toner container 9 to the developing roller 11 via transfer rollers 10 and 10′. By providing the transfer roller 10′, the quantity (thickness) of the liquid developer layer on the developing roller 11 can be severely controlled. In addition, in the image forming apparatus as shown in FIG. 2, the contact area between the developing roller 11 and the photoreceptor 1 is longer than that in the image forming apparatus as shown in FIG. 1 to sufficiently develop the electrostatic latent image. Further, a corona charger 80 is used as the image transfer device instead of the transfer roller 12.

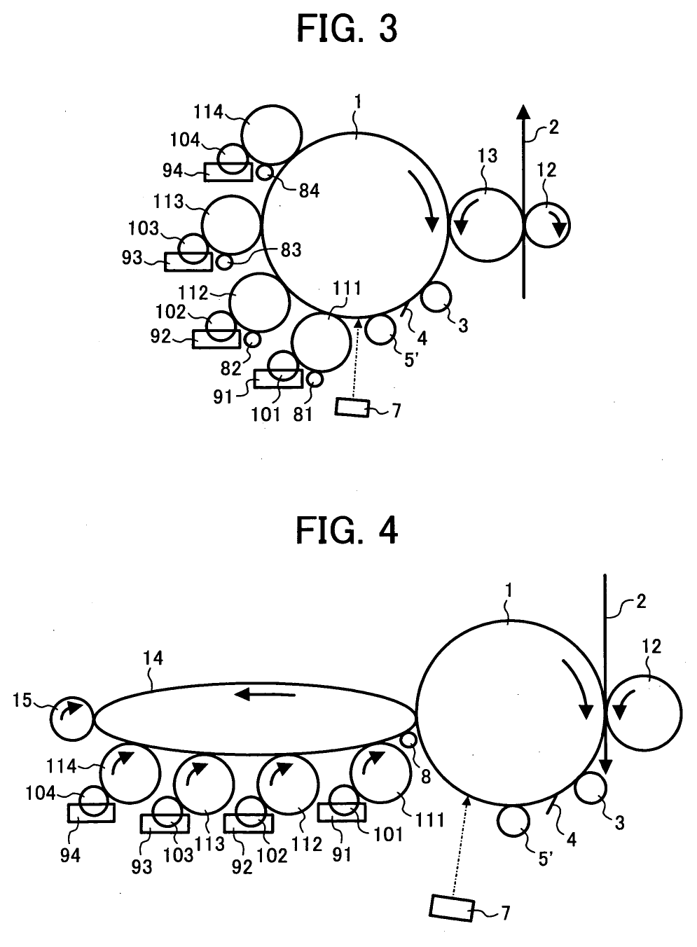

FIG. 3 is a schematic view illustrating another image forming apparatus which can be used for the image forming method of the present invention and which can produce color images. The image forming apparatus has toner containers 91, 92, 93 and 94 for yellow, magenta, cyan and black color liquid developers. The color liquid developers are transferred from the containers 91, 92, 93 and 94 by transfer rollers 101, 102, 103 and 104, respectively. Thus, yellow, magenta, cyan and black color liquid developer layers are formed on developing rollers 111, 112, 113 and 114. At first an electrostatic latent image is developed with, for example, a yellow color toner, which is formed on the developing roller 111. Thus, a yellow toner image is formed on the photoreceptor 1. The yellow toner image is transferred on an intermediate transfer roller 13. Similarly other toner images are also formed on the intermediate transfer roller 13. Thus, a full color toner image is formed on the intermediate transfer roller 13. The thus prepared full color toner image is then transferred on a receiving material 2 while the receiving material 2 is pressed by a transfer roller 12 toward the intermediate transfer roller 13. The toner image may be transferred upon application of corona charging or heat instead of pressure.

Numerals 81 to 84 denote a corona charger configured to charge the developer layers formed on the developing rollers 111 to 114. Numeral 5′ denotes a charging roller configured to charge the photoreceptor 1.

FIG. 4 is a schematic view illustrating another image forming apparatus which can be used for the image forming method of the present invention and which can produce color images. The image forming apparatus also has the toner containers 91, 92, 93 and 94 configured to contain a yellow liquid developer, a magenta liquid developer, a cyan liquid developer or a black liquid developer. Each developer is applied to a belt 14 from each of the toner containers 91, 92, 93 and 94 via the transfer rollers 101 to 104 and the developer rollers 111 to 114, to form a yellow toner image, a magenta toner image, a cyan toner image and a black toner image, one by one, on the photoreceptor 1. The yellow, magenta, cyan and black images are transferred onto a receiving material 2 one by one. A cleaning roller 15 and a cleaning blade (not shown) clean the surface of the belt 14.

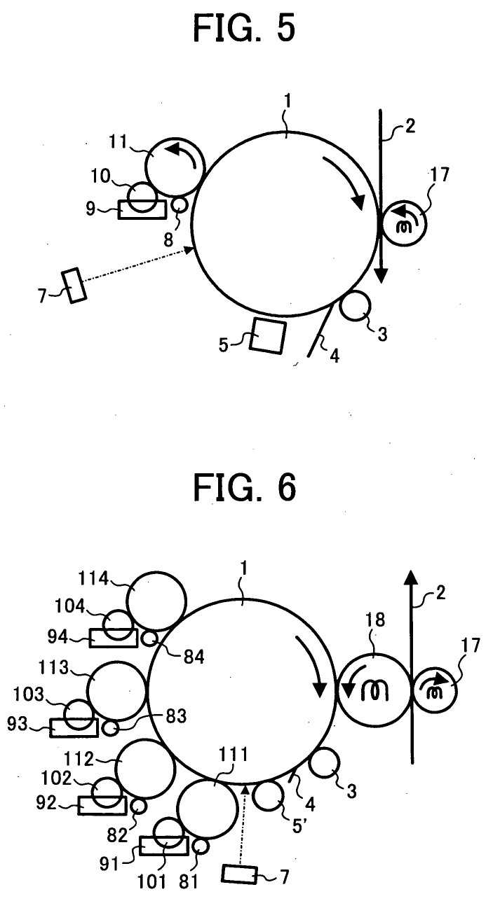

FIG. 5 is a schematic view illustrating another image forming apparatus for use in the image forming method of the present invention. In this image forming apparatus, a toner image formed on the photoreceptor 1 is transferred on the receiving material 2 and at the same time the toner image is fixed on the receiving material 2 while being pressed and heated by a pressure heat roller 17 containing a heater therein.

FIG. 6 is a schematic view illustrating another image forming apparatus for use in the image forming method of the present invention. The image forming apparatus includes a heat blanket 18 and a pressure heat roller 17. The image forming apparatus can fix a toner image at the same time when the toner image is transferred on the receiving material 2 using the heat bracket 18 and the pressure heat roller 17, at least one of which is heated.

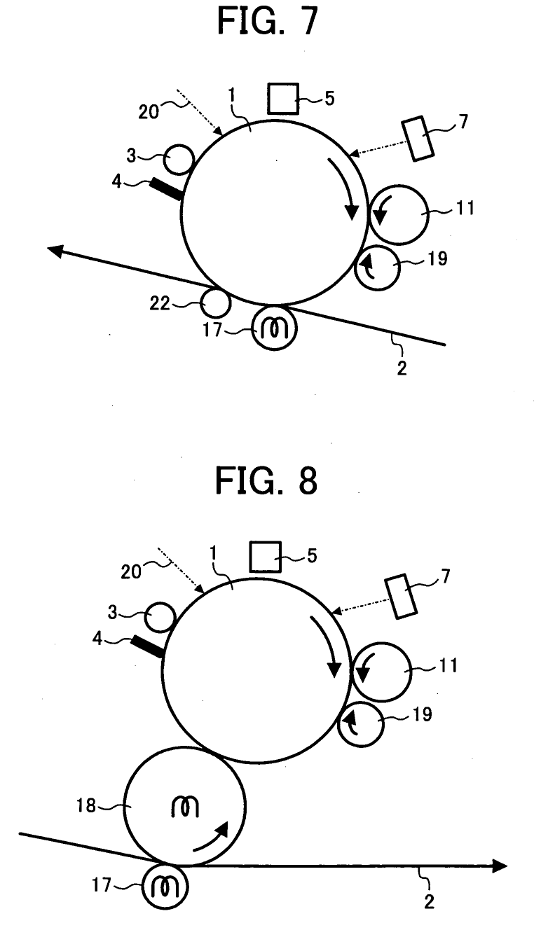

FIGS. 7 and 8 are other image forming apparatus for use in the image forming method of the present invention, in which a toner image is fixed at the same time when the toner image is transferred on the receiving material 2 using a diluted liquid developer having a solid content of from 0.1 to 3% by weight. In FIGS. 7 and 8, an electrostatic latent image formed by irradiation of light 7 is developed with the liquid developer layer formed on the developing roller 11, and the liquid developer remaining on the surface of the photoreceptor 1 is removed by a reverse roller 19 which rotates so as to counter the photoreceptor 1. Numerals 20 and 22 denote light emitted by a quenching lamp configured to reduce the charge remaining on the photoreceptor 1 even after the toner image is transferred, and a separation roller configured to separate the toner image from the photoreceptor 1, respectively.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Example 1

The following components were mixed and dispersed for 24
hours using a ball mill.

| | |
|---|---|
| Carbon black | 20 parts |
| (Manufactured by Cabot Corporation) | |
| Rosin-modified phenolic resin varnish | 50 parts |
| Linseed oil varnish | 10 parts |
| Manganese naphthenate | 2 parts |
| Poly-α-olefin | 50 parts |
| (SHF-41, from Exxon Mobil) | |

In addition, 100 parts of the poly-α-olefin (SHF-41) were added to the mixture, and the mixture was additionally dispersed for 1 hour. Thus, a printing ink (i.e., a stencil ink) was prepared.

The printing ink was set in a printing machine (PRIPORT manufactured by Ricoh Co., Ltd.) to print images. As a result, the resultant images were superior to those produced by a conventional ink consisting of a pigment and a linseed oil in image density, resolution and gloss. In addition, when printing was performed, the odor was relatively faint compared to that in a case where the conventional printing ink was used.

### Example 2

The following components were mixed and dispersed for 24
hours using a ball mill.

| | |
|---|---|
| Carmine 6B | 10 parts |
| (manufactured by Fuji Shikiso Kogyo K.K.) | |
| Phenolic resin | 30 parts |
| Electroconductivity imparting agent | 2 parts |
| Poly-α-olefin | 100 parts |
| (SHF-20, from Exxon Mobil) | |

In addition, 100 parts of the poly-α-olefin (SHF-20) were added to the mixture, and the mixture was additionally dispersed for 1 hour. Thus, an inkjet ink was prepared.

The printing ink was set in an inkjet printer to print images. As a result, the resulting images were superior to those produced by a conventional inkjet ink consisting of a pigment and isodode cane in image density and gloss. In addition, the clogging problem was not caused. Further, when printing was performed, the odor is relatively faint compared to that in a case where the conventional inkjet ink was used.

### Example 3

The following components were mixed and dispersed for 24 hours using a ball mill.

| | |
|---|---|
| VALIFAST RED #1605 | 7 parts |
| (manufactured by Orient | |
| Chemical Industries Co., Ltd.) | |
| Ketone resin | 10 parts |
| (HILAC 110H, from Hitachi Chemical Co., Ltd.) | |
| Poly-α-olefin | 48 parts |
| (SHF-82, from Exxon Mobil) | |
| Kerosene | 32 parts |

In addition, 100 parts of the poly-α-olefin (SHF-82) were added to the mixture, and the mixture was additionally dispersed for 1 hour. Thus, a marker ink was prepared. As a result, the resulting marker ink has good writing property and a problem specific to conventional marker inks including ethyl alcohol in that the image density decreases when images are continuously written was not caused. Further, the marker ink is far superior to conventional marker inks in odor and toxicity.

### Example 4

The following components were mixed and dispersed for 72 hours using a ball mill.

| | |
|---|---|
| Carbon black | 10 parts |
| (manufactured by Mitsubishi Chemical Corp.) | |
| Titanium oxide | 10 parts |
| Charge controlling agent | 1 part |
| Styrene-butadiene resin | 15 parts |
| Poly-α-olefin | 35 parts |
| (SHF-21, from Exxon Mobil) | |
| Liquid paraffin | 15 parts |
| (CRSTOL J52) | |

In addition, 150 parts of the poly-α-olefin (SHF-21) were added to the mixture, and the mixture was additionally dispersed for 1 hour. Thus, an electronic recording ink was prepared.

The electronic recording ink was contained in a display cell to record images. As a result, the electronic recording ink was superior to conventional electronic recording inks in response to application of voltage, durability, image qualities such as clearness and contrast, odor and safety (toxicity). In addition, even when the ink was adhered to hands, the ink could be easily removed by washing.

### Example 5

The following components were kneaded with a two-roll mill for 30 minutes at 140° C.

| | |
|---|---|
| Polyethylene | 70 parts |
| (SANWAX ® 151P | |
| from Sanyo Chemical | |
| Industries Ltd., softening | |
| point of 107° C.) | |
| Carbon black | 20 parts |
| (PRINTEX ® from Degussa) | |

The kneaded mixture was then pulverized to prepare a
colorant masterbatch.
Then the following components were mixed and dispersed
for 24 hours using a ball mill.

| | |
|---|---|
| Masterbatch prepared above | 50 parts |
| 20% poly-α-olefin solution of acrylic | |
| copolymer | 100 parts |
| (copolymer: lauryl | |
| methacrylate/methyl | |
| methacrylate/ | |
| methacrylic acid/glycidyl | |
| methacrylate (80/10/5/5), | |
| poly-α-olefin: | |
| SHF-41 from Exxon Mobil) | |
| Poly-α-olefin (SHF-41) | 200 parts |

In addition, 300 parts of a silicone oil (KF-96 from Shin-Etsu Chemical Co., Ltd., viscosity of 50 cst) were added to the mixture, and the mixture was additionally dispersed for 1 hour. Thus, a liquid developer of Example 5 was prepared.

### Example 6

The following components were kneaded with a two-roll mill at 120° C., followed by flushing using a flusher.

| | |
|---|---|
| Pigment Blue 15:3 | 15 parts |
| (from Dainichiseika Color & | |
| Chemicals Mfg. Co., Ltd.) | |
| Polyethylene | 90 parts |
| (SANWAX ® E300 from | |
| Sanyo Chemical Industries | |
| Ltd., softening | |
| point of 98° C.) | |

The mixture was then pulverized to prepare a colorant
masterbatch.
Then the following components were mixed and dispersed
for 36 hours using a ball mill.

| | |
|---|---|
| Masterbatch prepared above | 60 parts |
| 10% liquid paraffin solution of acrylic | |
| copolymer | 150 parts |
| (copolymer: stearyl | |
| methacrylate/methyl | |
| methacrylate/ | |
| methacrylic acid/ | |
| hydroxymethyl | |
| methacrylate (85/7/4/4), | |
| liquid paraffin: | |
| CRYSTOL J-142 | |
| from Esso Sekiyu KK) | |
| Poly-α-olefin (SHF-61) | 50 parts |

In addition, 350 parts of a silicone oil (KF-96 from Shin-Etsu Chemical Co., Ltd., viscosity of 100 cst) were added to the mixture, and the mixture was additionally dispersed for 1 hour. Thus, a liquid developer of Example 6 was prepared.

### Example 7

The following components were kneaded with a two-roll mill for 30 minutes at 80° C.

| | |
|---|---|
| Acrylic resin | 75 parts |
| (BR-102 from Mitsubishi | |
| Rayon Co., Ltd., softening | |
| point of 20° C.) | |
| Pigment Red 57:1 | 20 parts |
| (from Fuji Shikiso Kogyo K.K.) | |

The kneaded mixture was then pulverized to prepare a
colorant masterbatch.
Then the following components were mixed and dispersed
for 24 hours using a ball mill.

| | |
|---|---|
| Masterbatch prepared above | 50 parts |
| 20% poly-α-olefin solution of acrylic | |
| copolymer | 100 parts |
| (copolymer: lauryl | |
| methacrylate/glycidyl | |
| methacrylate | |
| (80/20), poly-α-olefin: | |
| SHF-83 from Exxon Mobil) | |
| Poly-α-olefin (SHF-83) | 300 parts |

In addition, 100 parts of the poly-α-olefin (SHF-61) were added to the mixture, and the mixture was additionally dispersed for 1 hour. Thus, a liquid developer of Example 7 was prepared.

### Comparative Example 1

The procedure for preparation of the liquid developer in Example 5 was repeated except that the poly-α-olefin SHF-41 was replaced with a silicone oil (KF-96 from Shin-Etsu Chemical Co., Ltd., viscosity of 100 cst).

Thus, a liquid developer of Comparative Example 1 was prepared.

### Comparative Example 2

The procedure for preparation of the liquid developer in Example 6 was repeated except that the poly-α-olefin SHF-61 was replaced with an isoparaffin (ISOPAR H from Exxon Mobil).

Thus, a liquid developer of Comparative Example 2 was prepared.

### Comparative Example 3

The procedure for preparation of the liquid developer in Example 7 was repeated except that the poly-α-olefin SHF-83 was replaced with a silicone oil (KF-96 from Exxon Mobil, viscosity of 50 cst).

Thus, a liquid developer of Comparative Example 3 was prepared.

Evaluation of Liquid Developer

Each of the liquid developers of Examples 5 to 7 and Comparative Examples 1 to 3 was set in an image forming apparatus having such a constitution as illustrated in FIG. 1 and having an oil-less heat fixing device including a heat roller and images were formed while the image forming conditions were controlled such that the image qualities were optimized. An amorphous silicon photoreceptor was used as the photoreceptor 1.

The data of the image qualities (i.e., image density, resolution, sharpness, solid image uniformity, and color reproducibility), transfer ratio of toner images, and offset resistance as shown in Table 2 were the data obtained under the most suitable recording conditions.

The evaluation items and methods are as follows:

(1) Image Density (ID)

The image density of the images formed on a plain paper (T-6000 from Ricoh Co., Ltd.) was measured by a densitometer manufactured by X-Rite.

(2) Resolution

Fine line images of the images formed on the plain paper T-6000 were observed to determine the resolution of the line images. The unit is lines per mm.

(3) Sharpness

The sharpness of the images formed on the plain paper T-6000 was graded into the following 5 ranks:

Rank 5: excellent

Rank 4: good

Rank 3: fair

Rank 2: bad

Rank 1: seriously bad

(4) Uniformity of Solid Image

The uniformity of the solid images formed on the plain paper T-6000 was graded into the following 5 ranks:

Rank 5: excellent

Rank 4: good

Rank 3: fair

Rank 2: bad

Rank 1: seriously bad

(5) Color Reproducibility (ΔE)

The color images formed on a special art paper (OK SPECIAL ART) were evaluated with respect to color tone using a color difference meter manufactured by X-Rite to obtain ΔE when compared to the color listed in Japan Color. When ΔE was determined, L* was not taken into consideration. This is because L* largely varies depending on the image density of the image to be measured.

(6) Average Particle Diameter (D)

The average particle diameter of the toner in each liquid developer was measured by an instrument SA-CP3 manufactured by Shimadzu Corporation.

(7) Transfer Ratio

Provided that the weight of a toner image formed on the image bearing member is (T) and the weight of the toner image which is formed by transferring the toner image on the image bearing member onto the receiving material is (T′), the transfer ratio is represented as (T′)/(T). Each developer was evaluated with respect to the transfer ratio.

(8) Offset Resistance

The images recorded on the plain paper T-6000 were observed whether an offset problem occurred. The quality of the images with respect to offset resistance was graded into the following 5 ranks:

Rank 5: excellent

Rank 4: good

Rank 3: fair

Rank 2: bad

Rank 1: seriously bad

TABLE 2

| | | | | | | | | Offset |
|---|---|---|---|---|---|---|---|---|
| | | Resolution | Sharpness | Uniformity | | D | T′/T | resistance |
| | ID | (l/mm) | (rank) | (rank) | ΔE | (μm) | (%) | (rank) |
| Ex. 5 | 1.32 | 7.1 | 4 | 4 | 1.3 | 0.81 | 85 | 5 |
| Ex. 6 | 1.47 | 7.1 | 5 | 4.5 | 3.9 | 1.19 | 80 | 5 |
| Ex. 7 | 1.38 | 7.1 | 4 | 4 | 2.5 | 0.82 | 83 | 4 |
| Comp. | 1.18 | 6.3 | 3 | 3 | 1.8 | 3.52 | 80 | 5 |
| Ex. 1 | | | | | | | | |
| Comp. | 1.26 | 6.3 | 3 | 3 | 6.7 | 2.20 | 86 | 3 |
| Ex. 2 | | | | | | | | |
| Comp. | 1.15 | 6.3 | 3 | 3 | 7.7 | 3.62 | 85 | 4 |
| Ex. 3 | | | | | | | | |

It is clear from Table 2 that the images produced by the liquid developer of Example 6 have higher image density and better solid image uniformity than those produced by the liquid developer of Example 5 because the liquid developer uses a colorant subjected to a flushing treatment. In addition, the offset resistance of the images produced by the liquid developer of Example 7 is slightly worse than that of the images produced by the liquid developers of Examples 5 and 6 for the following reasons:

(1) the binder resin has a softening point lower than 30° C.; and

(2) the liquid developer does not include silicone oil (i.e., the liquid developer includes only a poly-α-olefin as the carrier liquid).

It is clear from comparison of the developers of Examples 5 to 7 with the developers of Comparative Examples 1 to 3 that the liquid developer of the present invention is far superior to the comparative liquid developers in image density, resolution, sharpness, uniformity of solid image, color reproducibility and offset resistance. Although it is not described in Table 2, the liquid developer of the present invention is superior to the comparative liquid developer of Comparative Example 2 which uses an isoparaffin as the carrier liquid in odor when images are fixed by the heat roller (namely, when fixing is performed on the images produced by the developer of Examples 5 to 7, the amount of evaporated carrier liquid is much less than that in the case of using the liquid developer of Comparative Example 2). In addition, smell was hardly noticed.

### Example 8

The procedures for preparation and evaluation of the liquid developer in Example 5 were repeated except that images were formed using an image forming apparatus having such a constitution as shown in FIG. 2 in which the corona charger 8 applied a voltage of 3,000 V to the developer layer formed on the developing roller 11 such that the developer layer was subjected to corona discharging, before the image developing operation.

As can be understood from Table 3 below, the resolution of the images is improved.

TABLE 3

| | | | | | | | | Offset |
|---|---|---|---|---|---|---|---|---|
| | | Resolution | Sharpness | Uniformity | | D | T′/T | resistance |
| | ID | (l/mm) | (rank) | (rank) | ΔE | (μm) | (%) | (rank) |
| Ex. 8 | 1.33 | 8.0 | 4 | 4 | 1.3 | — | 88 | 5 |

### Example 9

The procedures for preparation and evaluation of the liquid developer in Example 6 were repeated except that images were formed using an image forming apparatus having such a constitution as shown in FIG. 5 which uses a transfer roller having a heater therein. By using this apparatus, the images produced by the liquid developer could be fixed at the same time when the images were transferred onto the receiving material.

As can be understood from Table 4 below, the image density (ID) and transfer ratio (T′/T) of the images are improved.

TABLE 4

| | | | | | | | | Offset |
|---|---|---|---|---|---|---|---|---|
| | | Resolution | Sharpness | Uniformity | | D | T′/T | resistance |
| | ID | (l/mm) | (rank) | (rank) | ΔE | (μm) | (%) | (rank) |
| Ex. 9 | 1.54 | 7.1 | 5 | 5 | 3.9 | — | 100 | 5 |

The procedures for preparation and evaluation of the liquid developer in Example 5 were repeated except that images were formed using an image forming apparatus having such a constitution as shown in FIG. 6 which uses a heat fixing roller. By using this apparatus, the images produced by the liquid developer could be fixed at the same time when the images were transferred onto the receiving material.

As can be understood from Table 5 below, the image density (ID) and transfer ratio (T′/T) of the images are improved.

TABLE 5

| | | | | | | | | Offset |
|---|---|---|---|---|---|---|---|---|
| | | Resolution | Sharpness | Uniformity | | D | T′/T | resistance |
| | ID | (l/mm) | (rank) | (rank) | ΔE | (μm) | (%) | (rank) |
| Ex. 10 | 1.58 | 7.1 | 5 | 5 | 3.9 | — | 98 | 5 |

### Example 11

The procedures for preparation and evaluation of the liquid developer in Example 6 were repeated except that images were formed using an image forming apparatus having such a constitution as shown in FIG. 4 in which a fluorine-containing acrylic block copolymer (MODIPER F210 manufactured by NOF Corporation) was applied to the surface of the photoreceptor to form thereon a water- and oil-repellant layer having a thickness of 3 μm. The contact angle formed by the liquid developer and the surface of the photoreceptor was 45°.

As can be understood from Table 6 below, the image density (ID) and transfer ratio (T′/T) of the images are improved.

TABLE 6

| | | | | | | | | Offset |
|---|---|---|---|---|---|---|---|---|
| | | Resolution | Sharpness | Uniformity | | D | T′/T | resistance |
| | ID | (l/mm) | (rank) | (rank) | ΔE | (μm) | (%) | (rank) |
| Ex. 11 | 1.60 | 7.1 | 5 | 4.5 | 3.9 | — | 90 | 5 |

### Example 12

One hundred (100) parts of the liquid developer of Example 7 were mixed with 300 parts of a poly-α-olefin, SHF-21 from Exxon Mobil, and 700 parts of an isoparaffin, ISOPAR M from Esso Sekiyu KK, to prepare a diluted liquid developer.

The diluted liquid developer was set in the image forming apparatus having such a constitution as illustrated in FIG. 7 to produce images. By using this apparatus, the images produced by the liquid developer could be fixed at the same time when the images were transferred onto the receiving material.

As can be understood from Table 7 below, the image qualities of the image produced by this diluted developer are almost the same as those of the images produced by the liquid developer of Example 7.

### Example 13

One hundred (100) parts of the liquid developer of Example 7 were mixed with 500 parts of a poly-α-olefin, SHF-21 from Exxon Mobil, and 500 parts of an isoparaffin, ISOPAR K from Esso Sekiyu KK, to prepare a diluted liquid developer.

The diluted liquid developer was set in the image forming apparatus having such a constitution as illustrated in FIG. 8, which uses a blanket, to produce images. By using this apparatus, the images produced by the liquid developer could be fixed at the same time when the images were transferred onto the receiving material.

As can be understood from Table 7 below, the image qualities of the image produced by this diluted liquid developer are almost the same as those of the images produced by the liquid developer of Example 7.

TABLE 7

| | | | | | | | | Offset |
|---|---|---|---|---|---|---|---|---|
| | | Resolution | Sharpness | Uniformity | | D | T′/T | resistance |
| | ID | (l/mm) | (rank) | (rank) | ΔE | (μm) | (%) | (rank) |
| Ex. 12 | 1.55 | 7.1 | 5 | 4.5 | 2.1 | — | 98 | 5 |
| Ex. 13 | 1.58 | 7.1 | 5 | 4.5 | 2.3 | — | 98 | 5 |

Effects of the Present Invention

In the recording liquid of the present invention, a colorant is dispersed in a carrier liquid including a poly-α-olefin. Therefore, the developer is superior in odor and safety, namely the developer is environmentally friendly. In addition, the developer has good preservability and the produced images have high gloss, good water resistance and good color reproducibility. Further, the images do not cause a tape releasing problem in that a tape adhered to the images is released therefrom.

When the recording liquid further includes a resin and/or a charge controlling agent, the recording liquid (liquid developer) has an improved preservability. In addition, the resultant images are further improved in image qualities such as image density, resolution and color reproducibility.

When a colorant subjected to a flushing treatment or a kneading treatment is used as the colorant, the resulting images are further improved in image qualities such as image density, uniformity of solid image, and fixability.

When the resin included in the developer has a softening point of from 30 to 120° C., the resultant developer has good preservability and the resultant images are further improved in image qualities such as fixability.

When a resin selected from the specific resins mentioned above is used as the resin, the resultant images are further improved in image qualities such as image density, uniformity of solid image, and fixability.

When the content of each of the resin and colorant in the recording liquid is not less than 5% by weight, the resultant images are further improved in image qualities such as image density.

When the average particle diameter of the colorant in the recording liquid is from 0.01 to 15 μm, the resulting images are further improved in image qualities such as image density and resolution.

When the recording liquid has a viscosity not less than 10 mPa.s, the recording liquid have good coating property, and thereby a thin layer can be uniformly formed on a developing member such as rollers or belts, resulting in improvement of image density and uniformity of solid image.

When the liquid developer includes a poly-α-olefin as the carrier liquid, which has a flash point not lower than 130° C., and a viscosity not lower than 3 mPa.s at 40° C., the images are further improved in offset-preventing properties.

When a silicone oil having a flash point not lower than 210° C. is further included in the liquid developer, the images are further improved in offset-preventing properties.

When a liquid such as liquid paraffins, the specified oils mentioned above, and aliphatic hydrocarbons is further included in the liquid developer, the images are further improved in offset-preventing properties.

In the image forming method of the present invention, an electrostatic latent image is developed with a thin layer of the liquid developer of the present invention formed on a roller or a belt, and thereby images having high image density, high resolution and good color reproducibility can be produced.

When a thin layer of the liquid developer is subjected to corona discharging before the developing operation, the resulting images are further improved in image qualities such as resolution and sharpness.

When a pre-wet liquid is applied to the electrostatic latent image area of the image bearing member before the developing operation, the images are further improved in transferability and image qualities such as image density.

When the images are transferred to a receiving material via an intermediate transfer medium, the images are further improved in transferability and image qualities such as image density and uniformity of solid image.

When the contact angle formed by the liquid developer and the surface of the image bearing member is not less than 30°, the images are further improved in transferability and image qualities such as image density and uniformity of solid image.

When the image formed on the image bearing member or the intermediate transfer medium is transferred onto a receiving material and is fixed thereon at the same time, the images are further improved in transferability and image qualities such as uniformity of solid image.

When an amorphous silicon photoreceptor is used as the image bearing member, high quality images can be produced for a long period of time.

Additional modifications and variations of the present invention are possible in light of the above teachings. It is therefore to be understood that within the scope of the appended claims the invention may be practiced other than as specifically described herein.

This document claims priority and contains subject matter related to Japanese Patent Application No. 2003-175333, filed on Jun. 19, 2003, the entire contents of which are herein incorporated by reference.

What is claimed as new and desired to be secured by letters patent of the united states is:

1. A recording liquid comprising a colorant and a non-aqueous carrier liquid, wherein the carrier liquid comprises a poly-α-olefin.

2. The recording liquid according to claim 1, further comprising a resin.

3. The recording liquid according to claim 2, wherein the resin has a softening point of from 30 to 120° C.

4. The recording liquid according to claim 2, wherein the resin comprises a member selected from the group consisting of ethylene/vinyl acetate copolymers, polyester resins, crystalline polyester resins, styrene/acrylic copolymers, rosin-modified resins, polyethylene resins, ethylene/acrylic acid copolymers, ethylene/methacrylic acid copolymers, and ethylene/acrylate copolymers.

5. The recording liquid according to claim 2, wherein each of the colorant and the resin is included in the recording liquid in an amount not less than 5% by weight based on total weight of the recording liquid.

6. The recording liquid according to claim 1, further comprising a charge controlling agent.

7. The recording liquid according to claim 1, wherein the recording liquid is a liquid developer for developing an electrostatic latent image.

8. The recording liquid according to claim 7, wherein the colorant dispersed in the liquid developer has an average particle diameter of from 0.01 to 15 μm.

9. The recording liquid according to claim 1, wherein the colorant has been subjected to a flushing treatment using a resin.

10. The recording liquid according to claim 1, wherein the recording liquid has a viscosity not lower than 10 mPa.s at 25° C.

11. The recording liquid according to claim 1, wherein the poly-α-olefin has a flash point not lower than 130° C. and a viscosity not lower than 3 mPa.s at 40° C.

12. The recording liquid according to claim 1, wherein the carrier liquid further comprises a member selected from the group consisting of silicone oils having a flash point not lower than 210° C., liquid paraffins, aliphatic hydrocarbons, vegetable oils, soybean oils, corn oils, caprylic/capric triglyceride, neopentyl glycol dicaprate, isooctyl ester of iso-octyl acid, and isonoyl ester of iso-nonanoic acid.

13. An image forming method comprising:
applying a recording liquid on a liquid bearing member to form a layer of the recording liquid according to claim 1; and
developing an electrostatic latent image born on an image bearing member by bringing the layer of the recording liquid into contact with the image bearing member to form a visual image on the image bearing member.

14. The image forming method according to claim 13, further comprising:
charging the layer of the recording liquid before the developing step.

15. The image forming method according to claim 13, further comprising:
wetting the image bearing member with a pre-wet liquid before the developing step.

16. The image forming method according to claim 13, further comprising:
transferring the visual image on the intermediate transfer medium onto a receiving material optionally via an intermediate transfer medium.

17. The image forming method according to claim 16, wherein the visual image is fixed on the receiving material at the same time when the visual image is transferred on the receiving material.

18. The image forming method according to claim 13, wherein a contact angle formed by the recording liquid and a surface of the photoreceptor is not less than 30°.

19. The image forming method according to claim 13, wherein the image bearing member is an amorphous silicon photoreceptor.
